(19) United States
(12) Patent Application Publication
(10) Pub. No.: US 2020/0384412 A1
(43) Pub. Date: Dec. 10, 2020

(54) METHOD FOR EXTRACTING A COMPOUND CONTAINED IN A LIQUID SOLUTION BY FORWARD OSMOSIS

(71) Applicant: EDERNA, TOULOUSE (FR)

(72) Inventors: FABRICE GASCONS VILADOMAT, TOULOUSE (FR); THOMAS MAUGIN, TOULOUSE (FR)

(73) Assignee: EDERNA, TOULOUSE (FR)

(21) Appl. No.: 16/314,345

(22) PCT Filed: Jul. 6, 2017
(86) PCT No.: PCT/FR2017/051843

§ 371 Date: Jan. 24, 2019

(30) Foreign Application Priority Data
Jul. 8, 2016 (FR) 1656606

(51) Int. Cl. B01D 61/00

(52) U.S. Cl. CPC B01D 61/005; B01D 2311/12; B01D 2311/2673

(57) ABSTRACT

A method for extracting a determined compound contained in a liquid solution, referred to as the feed solution, by forward osmosis. The feed solution is circulated in contact with a first face of a membrane configured to selectively allow the transfer of the compound by osmosis. A second liquid solution containing potassium lactate, referred to as the extraction solution, is circulated in contact with a second opposing face of the membrane opposite the first face.

The present invention lies in the field of the concentration of liquid solutions by osmosis methods, more particularly by forward osmosis methods.

More particularly, the present invention relates to a method for the extraction, by forward osmosis, of a given compound contained in a liquid solution, using an extraction solution having a particular composition. The invention also relates to an extraction solution for the implementation of such a method. It further relates to the use of potassium lactate in a forward osmosis method.

Generally speaking, osmosis is defined as the transfer of a solvent from a dilute solution, with low osmotic pressure, to a concentrated solution, with a higher osmotic pressure, through a semipermeable membrane, more precisely permeable to said solvent but not to the solutes.

In particular, in the methods achieving extraction of solvent from a liquid solution by forward osmosis, referred to as forward osmosis methods, the solvent to be extracted from the solution, referred to as the feed solution, is put in contact with a first face of a semipermeable membrane, generally the face on which an active layer of the membrane is disposed. Another solution, referred to as the extraction solution, is put in contact with the opposite face of the membrane, generally the face on which a so-called support layer of the membrane is disposed. The extraction solution is typically in an aqueous solution with a high concentration of a salt with a high osmotic pressure. When the method is implemented, the solvent is transported, through the membrane, from the feed solution to the extraction solution, that is to say from the solution with the lower osmotic pressure to the solution with the higher osmotic pressure, the driving force of the system being related to the difference in osmotic pressure between the two solutions. These methods are generally used for extracting water from the feed solution. They may also be used in a similar manner for extracting any compound of interest other than water from the feed solution, by a suitable choice of the membrane and of the extraction solution.

Forward osmosis methods have been used for a long time for the desalination of sea water.

More recently, the prior art has proposed using forward osmosis for concentrating liquid solutions of interest, for example in the food field, the health field or the cosmetic field, by extracting some or all of the water contained in these solutions. The advantage of this technology is in particular that it makes it possible to concentrate the solution of interest while keeping the other compounds intact therein, including heat-sensitive compounds. This proves in particular to be entirely advantageous in the cases where these other compounds are of high added value, such as flavourings, vitamins, natural dyes, active principles, etc.

The extraction solutions used conventionally in such methods are aqueous solutions containing a salt such as sodium chloride, calcium chloride or calcium nitrate for example. These solutions are normally referred to as osmotic agents.

It has in particular been proposed, by the prior art, illustrated for example by the document WO-A-2013/148289, or by the document KR 2015 0070895, to use, as the extraction solution, an aqueous solution containing a water-soluble surfactant, more particularly an anionic surfactant, such as sodium lactate.

The osmotic agents proposed by the prior art, and compatible with the food field, do however all have drawbacks, in particular low efficacy and/or strong retrodiffusion of the salts through the membrane. The term retrodiffusion is used here to designate the phenomenon according to which the salt contained in the extraction solution diffuses through the membrane to the feed solution, which obviously proves to be prejudicial when the feed solution is a solution containing compounds with high added value, which the forward osmosis method aims to concentrate and/or purify.

The present invention aims to remedy the drawbacks of the methods proposed by the prior art for the extraction by the forward osmosis technique of a given compound from a liquid solution that contains it, by proposing a forward osmosis method that makes it possible to carry out such extraction quickly and effectively, together with limiting the retrodiffusion of the salt of the osmotic agent through the membrane.

Thus, according to a first aspect, the present invention proposes a method for the extraction by forward osmosis of a given compound contained in a liquid solution, referred to as the feed solution, according to which: the feed solution is circulated in contact with a first face of a membrane able to selectively allow the transfer by osmosis of the given compound through it, and a second liquid solution, referred to as the extraction solution, is circulated in contact with a second face of the membrane opposite to the first face. The extraction solution contains potassium lactate, in solution in a solvent.

Preferably, potassium lactate is the majority component in solution in the solvent of the extraction solution. Preferentially, the extractions solution consists essentially of potassium lactate in solution in the solvent.

The term solvent here also encompasses mixtures of solvents.

It has been found by the present inventors that potassium lactate makes it possible to achieve an extraction of the given compound from the feed solution more quickly than the great majority of the osmotic agents proposed by the prior art for forward osmosis.

Furthermore, highly surprisingly, it has been found by the present inventors that potassium lactate makes it possible to achieve an extraction that is at least as rapid as, and which moreover is accompanied by a lower retrodiffusion, than sodium lactate. This result is all the more unexpected since it is well known to persons skilled in the art that, for the same anion, the salts containing potassium diffuse more quickly through membranes than their homologues having sodium as the cation. Thus, a person skilled in the art would have in no way envisaged using potassium lactate as an alternative to sodium lactate for forming osmotic agents for forward osmosis.

In particular, when the forward osmosis method according to the invention is implemented, the retrodiffusion flow of the potassium lactate through the membrane is very low, and the ratio of the flow of the given compound extracted from the feed solution to the retrodiffusion flow (that is to say the volume of the given compound extracted from the feed solution, per gram of salt that is diffused from the extraction solution into the feed solution) is particularly high. This reflects great efficacy of the forward osmosis method according to the invention.

Such efficacy is all the greater at high concentrations of potassium lactate in the extraction solution, in particular at concentrations greater than or equal to 5 mol/litre.

The potassium lactate recommended by the present invention further has the advantages of being compatible with use in the food field, in contact with food, as well as being compatible with the membranes used conventionally in the field of forward osmosis methods, for example with membranes made from cellulose triacetate.

In the great majority of cases, the given compound to be extracted from the feed solution by the method according to the invention is water. In such cases, the extraction solution according to the invention is advantageously an aqueous solution containing potassium lactate. The invention does not however exclude the method according to the invention being implemented for extracting any other compound of interest from the feed solution, through a suitable choice firstly of the membrane and secondly of the solvent forming part of the extraction solution.

In particular embodiments of the invention, the extraction solution is an aqueous solution containing potassium lactate, which further preferably constitutes the majority component in the aqueous vehicle, that is to say the component present in the greatest quantity. Preferentially, the extraction solution comprises mainly potassium lactate in solution in water.

In particular embodiments of the invention, the concentration of potassium lactate in the extraction solution is between 5 and 9.4 mol/litre. As disclosed previously, at such concentrations, the efficacy of the forward osmosis method according to the invention is particularly high.

The concentration of 9.4 mol/litre, which corresponds to the maximum acceptable viscosity concentration of the extraction solution for implementing the forward osmosis method, is particularly preferred in the context of the invention, since it makes it possible to obtain very high performances of extraction of the given compound from the feed solution.

In particular embodiments of the invention, the chosen membrane comprises, at the first face, a so-called active layer and, at the second face, a so-called support layer, the active layer being denser than the support layer. According to the invention, the feed solution is thus put in contact with the active layer of the membrane, and the extraction solution with the support layer.

Such a feature advantageously makes it possible to obtain greater efficacy of the forward osmosis method according to the invention, in particular in terms of selectivity vis-à-vis the compounds transferred through the membrane.

However, embodiments in which the first face of the membrane, in contact with the feed solution, is formed by a support layer, and the second face of the membrane, in contact with the extraction solution, is formed by a denser active layer, are however not excluded from the present invention.

Any other configuration of the membrane also falls within the scope of the present invention, for example configurations in which the membrane comprises two active layers between which a support layer is interposed, each of the feed solution and extraction solution then being in contact with an active layer. Among these active layers, one may be denser than the other.

In particular embodiments of the invention, the method comprises a final step of regeneration of the extraction solution, that is to say of the potassium lactate solution, by elimination of all or part of the given compound that it contains, which has in particular been extracted from the feed solution. This regeneration step may in particular be carried out by evaporation of said given compound, in particular when the latter is water. Such regeneration is in particular made possible by a particular characteristic of the potassium lactate recommended by the invention, namely good stability under heat.

According to another aspect, the present invention relates to an extraction solution for the implementation of a method for the extraction by forward osmosis of a given compound contained in a liquid solution, in particular of a method according to the present invention, meeting one or more of the features disclosed above. This extraction solution contains potassium lactate.

Preferentially, this extraction solution consists of an aqueous solution containing potassium lactate. The potassium lactate is preferably the majority component contained in the aqueous vehicle, and preferentially essentially the only component contained in the aqueous vehicle.

The concentration of potassium lactate in the extraction solution is preferably between 5 and 9.4 mol/litre.

According to a third aspect, the present invention relates to the use of potassium lactate in a method for the extraction by forward osmosis of a given compound contained in a liquid solution.

According to the invention, potassium lactate is used as a component, preferably a majority component, of the extraction solution used in the forward osmosis method, in solution in a solvent.

This extraction solution may comply with one or more of the features described above with reference to the method according to the invention, for the extraction by forward osmosis of a given compound contained in a liquid solution.

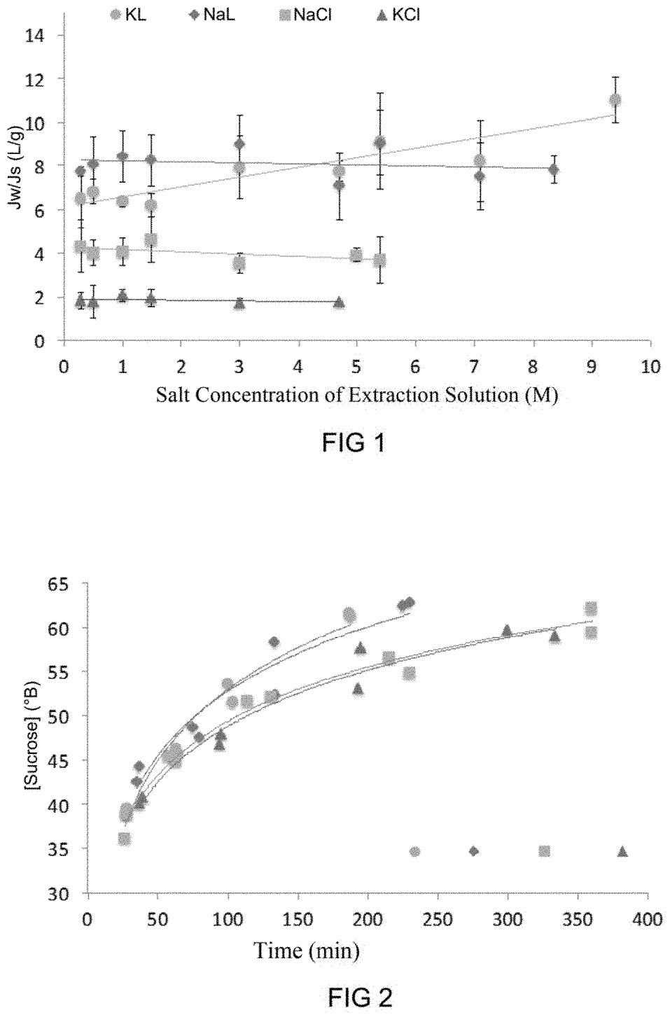

The features and advantages of the invention will emerge more clearly in the light of the example embodiments below, provided simply by way of illustration and in no way limitative of the invention, with the help of FIGS. 1 to 3, wherein:

FIG. 1 depicts a graph showing the specific salt flow (Jw/Js) according to the initial salt concentration of the extraction solution, at the end of a method for the extraction of water by forward osmosis from a feed solution consisting solely of water, for extraction solutions comprising respectively potassium lactate (KL), sodium lactate (NaL), potassium chloride (KCl) and sodium chloride (NaCl);

FIG. 2 depicts a graph showing the sucrose concentration of the feed solution as a function of time, during the implementation of a method for the extraction of water by forward osmosis from a feed solution consisting of sucrose in an aqueous vehicle, for extraction solutions comprising respectively potassium lactate (KL), sodium lactate (NaL), potassium chloride (KCl) and sodium chloride (NaCl); and

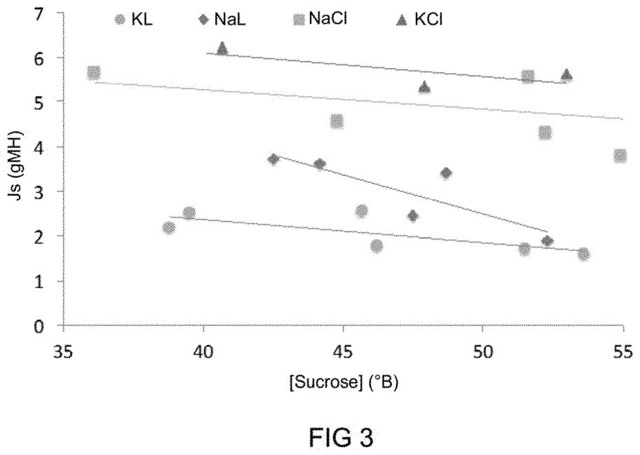

FIG. 3 depicts a graph showing the retrodiffusion flow of the salt (Js) through the membrane as a function of the sucrose concentration in the feed solution, during the implementation of a method for the extraction of water by forward osmosis from a feed solution consisting of sucrose in an aqueous vehicle, for extraction solutions comprising respectively potassium lactate (KL), sodium lactate (NaL), potassium chloride (KCl) and sodium chloride (NaCl).

### A) FORWARD OSMOSIS DEVICE AND METHOD

For the following experiments, use is made of a forward osmosis device that is conventional per se, consisting of a cell (CF042A, Sterlitech) comprising a semi-permeable membrane and two closed circuits, in which there circulate respectively, in contact with the membrane, on the one hand the feed solution containing the compound to be extracted, and on the other hand the extraction solution.

The membrane used is a commercially-available membrane formed from cellulose triacetate (CTA) (Hydration Technology Innovations) having an active surface area of 42 cm². The active layer of the membrane is placed in contact with the circuit for circulation of the feed solution, and the support layer of the membrane is placed in contact with the circuit for circulation of the extraction solution.

Each solution is driven in the associated circuit by a peristaltic pump at a rate of 40 litres/hour.

### B) EXPERIMENTS

In the following experiments, various extraction solutions were tested, comprising respectively, in solution in water:
potassium lactate in accordance with the present invention;
by way of comparison, various compounds proposed by the prior art: sodium lactate, potassium chloride or sodium chloride.

In particular, sodium chloride is used as a reference osmotic agent since it is abundantly studied in the prior art.

For each of these salts, various concentrations are tested.

### B.1) Series of Experiments 1

In a first series of experiments, the performances of the forward osmosis system obtained with the above four extraction solutions are compared under “ideal” conditions of use, in which pure water is used as the feed solution, the compound to be extracted therefrom being water.

The initial ranges of concentrations of salt in the extraction solution tested range from 0.3 M (for the minimum concentration) to the saturation or maximum acceptable viscosity concentration of each osmotic agent: 4.7 M for potassium chloride (KCl), 5.4 M for sodium chloride (NaCl), 9.4 M for potassium lactate (KL) and 8.5 M for sodium lactate (NaL).

Each test lasts for 30 minutes.

The initial and final volumes of feed solution and extraction solution, as well as the initial and final conductivities of the feed solution, are recorded.

These conductivities make it possible to calculate the concentrations of salts in the solutions. The flows of water extracted (Jw in l/(m²·h) or LMH) and the retrodiffusion flow of the salt (Js in g/(m²·h) or gMH) through the membrane are then calculated, as well as the specific salt flow (Jw/Js in l/g), representing the volume of water extracted per gram of salt that has diffused in the feed solution. A high value of this index indicates better performance of the osmotic agent.

The results obtained for each salt tested, in terms of specific salt flow (Jw/Js) as a function of the initial salt concentration in the extraction solution are shown in FIG. 1.

It is seen therein that the specific salt flow obtained for the method according to the present invention, using potassium lactate, is much higher than that obtained for potassium chloride and for sodium chloride, at all the concentrations tested. It is also higher than that obtained for sodium lactate at the highest concentrations, greater than or equal to approximately 5 M.

### B.2) Series of Experiments 2

In a second series of experiments, the performances of the forward osmosis system obtained with the four extraction solutions described above are compared for the concentration of an aqueous solution of sucrose of 30° B to 60° B, the compound to be extracted therefrom being water.

The initial salt concentrations in the extraction solution tested are: 4.7 M for potassium chloride (KCl), 5.4 M for sodium chloride (NaCl), 9.4 M for potassium lactate (KL) and 8.5 M for sodium lactate (NaL).

50 ml of a sucrose solution (feed solution) and 1 litre of extraction solution are introduced into the forward osmosis system.

Flow measurements and takings of samples for the determination of the salt concentrations are carried out at each 20 ml of water extracted from the feed solution. The concentrations of lactate that has retrodiffused in the feed solution are analysed with enzymatic kits. A volume of 20 ml of feed solution with a sucrose concentration at 30° B is then added to the system. In this way, the volume of feed solution always varies between 70 ml and 50 ml (the dead volume of the system being 50 ml).

The flows of water extracted (Jw in l/(m²·h)) and the flows of retrodiffusion of salt (Js in g/(m²·h)) are then calculated.

The results obtained, in terms of sucrose concentration in the feed solution as a function of time, are shown in FIG. 2. It can be seen therein that the concentration of the model sucrose solution up to 60° B takes place more quickly when the extraction solution contains potassium lactate or sodium lactate.

The change in the retrodiffusion flow of the salt (Js) through the membrane, according to the sucrose concentration in the feed solution, is shown in FIG. 3. During the concentration of the feed solution, it is observed that the flow of retrodiffused salt decreases when the sucrose concentration of the feed solution increases, whatever the salt used. This is easily explained by the fact that, during the concentration of the feed solution, the osmotic pressure of the latter increases and therefore the difference in osmotic pressure between the feed solution and the extraction solution decreases.

It is further observed that potassium lactate is associated with a lower retrodiffusion flow than the other salts studied. These results are consistent with those obtained with pure water as feed solution.

The flow of sucrose through the membrane was also calculated for each salt tested. It reaches a value of 0.10 gMH, with a variation of 0.07 gMH, whatever the salt used. The use in accordance with the present invention of an extraction solution based on potassium lactate therefore does not have a negative impact on the passage of sugar through the membrane, compared with the other salts tested.

1-9. (canceled)

10. A method for extracting a given compound contained in a liquid solution by forward osmosis, the liquid solution being referred to as a feed solution, comprising steps of circulating the feed solution circulated in contact with a first face of a membrane configured to selectively allow a transfer of the given compound by the forward osmosis; and circulating a second liquid solution, referred to as an extraction solution, in contact with a second face of the membrane opposite to the first face of the membrane, wherein the extraction solution contains potassium lactate.

11. The method according to claim 10, wherein the extraction solution is an aqueous solution containing potassium lactate.

12. The method according to claim 10, wherein a concentration of potassium lactate in the extraction solution is between 5 and 9.4 mol/l.

13. The method according to claim 10, further comprising a final step of regenerating the extraction solution, by eliminating the given compound contained in the extraction solution, by evaporation of the given compound.

14. The method according to claim 10, wherein the membrane comprises an active layer at the first face and a support layer at the second face, the active layer being denser than the support layer.

15. A method for extracting a given compound contained in a liquid solution by forward osmosis, comprising a step of using potassium lactate.
